(19) United States
(12) Patent Application Publication
(10) Pub. No.: US 2024/0238987 A1
(43) Pub. Date: Jul. 18, 2024

(54) APPARATUS WITH TOOLS FOR ROBOTIC PAINT REPAIR

(71) Applicants: Joseph Brian Eckel, Vadnais Heights, MN (US); Andrew Gary Gagne, Orion Township, MI (US); Nathan J. Herbst, Woodbury, MN (US); Kyle Lee Mantecon, Brighton, MI (US); Aaron Kent Nienaber, Lake Elmo, MN (US)

(72) Inventors: Joseph Brian Eckel, Vadnais Heights, MN (US); Andrew Gary Gagne, Orion Township, MI (US); Nathan J. Herbst, Woodbury, MN (US); Kyle Lee Mantecon, Brighton, MI (US); Aaron Kent Nienaber, Lake Elmo, MN (US)

(21) Appl. No.: 18/560,158

(22) PCT Filed: May 10, 2022
(86) PCT No.: PCT/US2022/072225

§ 371 Date: Nov. 10, 2023

Related U.S. Application Data
(60) Provisional application No. 63/201,750, filed on May 11, 2021.

(51) Int. Cl. B25J 15/00; B25J 9/16; B25J 11/00

(52) U.S. Cl. CPC B25J 15/0066; B25J 9/1682; B25J 11/0065; B25J 15/0019

(57) ABSTRACT

A robotic paint repair system is disclosed. The system optionally including a robotic arm, a first tool system and a fluid removal tool. The first tool system can comprise a first end effector coupled to a first tool configured to contact a workpiece to perform surface modification of the workpiece. The first end effector can be configured to actuate the first tool about a first axis to perform the surface modification of the workpiece. The fluid removal tool can comprise a wiping medium. The fluid removal tool can be coupled to the robot arm. The fluid removal tool can be configured to actuate the wiping medium about or along a second axis to remove fluid from the workpiece. The first axis can be offset from the second axis and the first axis can be within 45 degrees of parallel with the second axis.

### PRIORITY CLAIM

This application claims the benefit of priority to U.S. Provisional Patent Application Ser. No. 63/201,750, filed May 11, 2021, the contents of which are incorporated herein by reference in their entirety.

### TECHNICAL FIELD

This disclosure relates to surface modification and wiping tools, and more particularly, to robotically implemented repairs using surface modification tools and wiping tools.

### BACKGROUND

The automotive industry often needs to prepare surfaces of vehicle parts or replacement parts (e.g., a bumper) for various purposes (e.g., painting), or to repair surfaces of car parts or replacement parts due to defects incurred during painting or coating. Typical surface preparation processes include, for example, physically surface modification car surfaces, or “scuffing”. Typical repair operations often include, for example, surface modification such as sanding and polishing. Surface preparation and repair of defects on surfaces can utilize different tools, materials and fluids.

In the automotive industry, clear coat repair has not been automated in the automotive original equipment manufacturing (OEM) and aftermarket sectors. Techniques are desired for automating this process as well as other paint applications (e.g., primer sanding, clear coat defect removal, clear coat polishing, etc.) amenable to the use of abrasives and/or robotic inspection and repair.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

This disclosure describes systems, apparatuses, methods and techniques related to various problems in automating defect-specific repairs for paint applications. Current processes of having a human manually wipe a workpiece surface after each surface modification step. This is time consuming. The process time of automated paint repair could be improved by streamlining or automating the fluid removal process step. However, automated techniques have not been developed to wipe away residue after surface modification (e.g., after sanding or polishing). The present inventors have invented systems, apparatuses, methods and techniques that allow for automated wiping of a workpiece. Furthermore, the present inventors recognize that transition time between sanding and wiping or polishing and wiping can be improved. For example, the present inventors propose that an actuation axis of the wiping medium be mounted in a substantially parallel manner to an actuation axis of the sanding or polishing tool. This can reduce transition time and improve line throughput as the wrist of robotic arm does not have to reoriented to transition between sanding and wiping or polishing and wiping, for example. Thus, throughput of the production line can be improved.

The present inventors further recognize that the substantially parallel mounting orientation of the wiping medium relative to the sanding or polishing tool can reduce the likelihood of interference or collision of these tools with other objects such as the workpiece as the tools to do not have to be reoriented about an axis to reposition the wiping medium to perform wiping after sanding or polishing.

The details of one or more examples of the disclosure are set forth in the accompanying drawings and the description below. Other features, objects, and advantages of the disclosure will be apparent from the description, drawings, and claims.

The disclosure herein includes but is not limited to the following illustrative Examples:

Example 1 is a robotic paint repair system optionally including a robotic arm, a first tool system and a fluid removal tool. The first tool system can comprise a first end effector coupled to a first tool configured to contact a workpiece to perform surface modification of the workpiece. The first end effector can be configured to actuate the first tool about a first axis to perform the surface modification of the workpiece. The fluid removal tool can comprise a wiping medium. The fluid removal tool can be coupled to the robot arm. The fluid removal tool can be configured to actuate the wiping medium about or along a second axis to remove fluid from the workpiece. The first axis can be offset from the second axis and the first axis can be within 45 degrees of parallel with the second axis.

Example 2 is the robotic paint repair system of Example 1, wherein the first axis and the second axis can be substantially parallel being no more than 5 degrees from parallel in orientation.

Example 3 is the robotic paint repair system of any one of Examples 1-2, wherein the first tool system can be coupled to the robotic arm offset from the fluid removal tool.

Example 4 is the robotic paint repair system of any one of Examples 1-3, optionally further comprising a second tool system comprising a second end effector coupled to a second tool configured to contact the workpiece, wherein the second tool system is coupled to the robotic arm.

Example 5 is the robotic paint repair system of Example 4, wherein the first and second tools can be positioned between 90 degrees and 180 degrees apart, inclusive, on the robotic arm.

Example 6 is the robotic paint repair system of any one of Examples 4-5, wherein the fluid removal tool, the first end effector, and the second end effector can be mounted to a same force control device.

Example 7 is the robotic paint repair system of any one of Examples 1-6, wherein the wiping medium can be extensible and retractable axially along the second axis relative to the first tool.

Example 8 is the robotic paint repair system of any one of Examples 1-7, wherein surface modification of the workpiece can include one of sanding, polishing or buffing the workpiece.

Example 9 is the robotic paint repair system of any one of Examples 1-8, wherein the first tool system can be coupled to the robotic arm via a flange along with the fluid removal tool, and wherein the flange does not change a rotational orientation between the first tool performing the surface modification of the workpiece and the wiping medium removing fluid from the workpiece.

Example 10 is the robotic repair system of any one of Examples 1-8, wherein the first tool system can be coupled to the robotic arm via a flange along with the fluid removal tool, and wherein the flange can have a limited rotational orientation change between the first tool performing the surface modification of the workpiece and the wiping medium removing fluid from the workpiece.

Example 11 is the robotic paint repair system of any one of Examples 1-3 and 7-10, wherein the first tool system can be coupled to a second robotic arm.

Example 12 is the robotic paint repair system of any one of Examples 1-11, wherein the fluid comprises a sanding slurry.

Example 13 is the robotic paint repair system of any one of Examples 1-12, wherein the fluid removal tool and the first end effector can be mounted to a same force control device.

Example 14 is a robotic paint repair system that can include a robotic arm, a first tool system, a second tool system and a fluid removal tool. The first tool system can comprise a first end effector coupled to a first tool configured to contact a workpiece to perform a first surface modification of the workpiece. The first end effector can be configured to actuate the first tool about a first axis to perform the first surface modification of the workpiece. The second tool system can comprise a second end effector coupled to a second tool configured to contact the workpiece. The fluid removal tool can comprise a wiping medium. The fluid removal tool can be coupled to the robot arm. The fluid removal tool can be configured to actuate the wiping medium about or along a second axis to remove fluid from the workpiece. The first axis can be offset from and can be substantially parallel with the second axis.

Example 15 is the robotic paint repair system of Example 14, wherein the first tool and the second tool can be coupled to the robotic arm via a same force controller. The second tool can be configured to perform one of a second surface modification of the workpiece or a second removal of fluid from the workpiece.

Example 16 is the robotic paint repair system of any one of Examples 14-15, wherein the wiping medium can be extensible and retractable axially along the second axis relative to the first tool or the second tool.

Example 17 is the robotic paint repair system of any one of Examples 14-16, wherein the first tool system can be coupled to the robotic arm via a flange along with the fluid removal tool, and wherein the flange does not change a rotational orientation between the first tool performing the first surface modification of the workpiece and the wiping medium removing fluid from the workpiece.

Example 18 is the robotic paint repair system of any one of Examples 14-17, wherein at least one of the first tool system and the second tool system can be coupled to a second robotic arm.

Example 19 is the robotic repair system of any one of Examples 14-18, wherein the first axis and the second axis are no more than 5 degrees from parallel in orientation.

Example 20 is a method of performing automated paint repair on a workpiece. The method can optionally include: actuating a first tool mounted to a robotic arm to perform surface modification of the workpiece, moving a tool configured to perform wiping of the workpiece without manipulating a rotational axis of a wrist of the robotic arm, and wiping of the workpiece with the tool.

Example 21 is the method of Example 20, wherein surface modification of the workpiece can include one of sanding, polishing or buffing the workpiece.

Example 22 is the method of any one of Examples 20-21, optionally further comprising: reorientating the wrist about the rotational axis, and actuating a second tool mounted to the robotic arm via the wrist to perform buffing of the workpiece after the wiping of the workpiece.

Example 23 is the method of any one of Examples 20-21, optionally further comprising: actuating a second tool to perform buffing of the workpiece after the wiping of the workpiece, and wiping of the workpiece after the buffing of the workpiece.

Example 24 is the method of any one of Examples 20-23, wherein the surface modification of the workpiece by the first tool can be performed about a first axis and the wiping of the workpiece after surface modification the workpiece is performed about or along a second axis, and wherein the first axis can offset from and substantially parallel with the second axis.

Example 25 is the method of Example 24, wherein the first axis and the second axis can be no more than 5 degrees from parallel in orientation.

Example 26 is the method of any one of Examples 20-25, optionally further comprising extending or retracting a wiping solution that is configured to perform the wiping axially along a second axis relative to the first tool.

Example 27 is a method of performing automated paint repair on a workpiece.

The method can optionally include: actuating a first tool mounted to a robotic arm to perform surface modification of the workpiece, moving a tool configured to perform wiping of the workpiece with limited manipulation about a rotational axis of a wrist of the robotic arm, and wiping of the workpiece with the tool.

Example 28 is the method of Example 27, wherein the limited manipulation about the rotational axis of the wrist can be between 0.1 degrees and 45 degrees, inclusive.

### BRIEF DESCRIPTION OF DRAWINGS

FIG. 1 is a schematic diagram illustrating an example system for robotic paint repair using paint repair robots that manipulate an surface modification tool and a wiping medium in accordance with one example of the present application.

FIG. 1A is a schematic diagram of portions of the paint repair robots and the surface modification tool and wiping medium of the system of FIG. 1, in accordance with one example of the present application.

FIG. 2 is a schematic diagram of portions of another robotic pain repair system including portions of paint repair robots that manipulate a sanding tool, the wiping medium and a polishing tool, in accordance with an example of the present application.

FIG. 3 is a schematic view of a dual parallel mounted end effector system of a paint repair robot in accordance with one example of the present application.

FIG. 3A is a schematic view of a triple mounted end effector system of a paint repair robot, in accordance with one example of the present application.

FIGS. 4A and 4B are views of the triple mounted end effector system of FIG. 3A from different perspectives showing the wiping medium in a retracted position, in accordance with one example of the present application.

FIGS. 5A and 5B are views of the triple mounted end effector system of FIG. 3A from different perspectives showing the wiping medium in an extended position, in accordance with one example of the present application.

FIG. 6 is a schematic diagram of a robotic repair system, in accordance with one example of the present application.

FIG. 7 is a flow diagram of a method of performing automated paint repair on a workpiece, in accordance with one example of the present application.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides an automated system and methods of using robotic repair unit with an end-of-arm system with mounted tools for surface modification of an object surface. The automated systems and methods also allow for end-of-arm removal of debris such as by wiping. This can be via a debris removal tool which may be utilized before, after and/or between the surface modification. As discussed previously, a wiping medium can be mounted substantially parallel with one or more of the tools that perform the surface modification. This arrangement can reduce processing time as additional manipulations of the wrist of the paint repair robot need not be performed. The present application also recognizes other benefits such as reduced part count (a single force control unit can be used for both wiping and surface modification) and reduced likelihood of interference or collision of these tools with other objects such as the workpiece.

The processing tools along with the fluid removal tool can be mounted on an end effector at the end of a motive robot arm, such that they capable of moving between various areas on a workpiece together as a unit. The surface modification tool may include a functional component configured to contact and prepare the object surface and one or more sensors configured to detect working state information of the end-effector tool. The end effector can include as part of the wiping tool or surface modification tool a dispenser for fluid while the functional component contacts and prepares the object surface. Various sensors include a force sensor can also be utilized in conjunction with the processing.

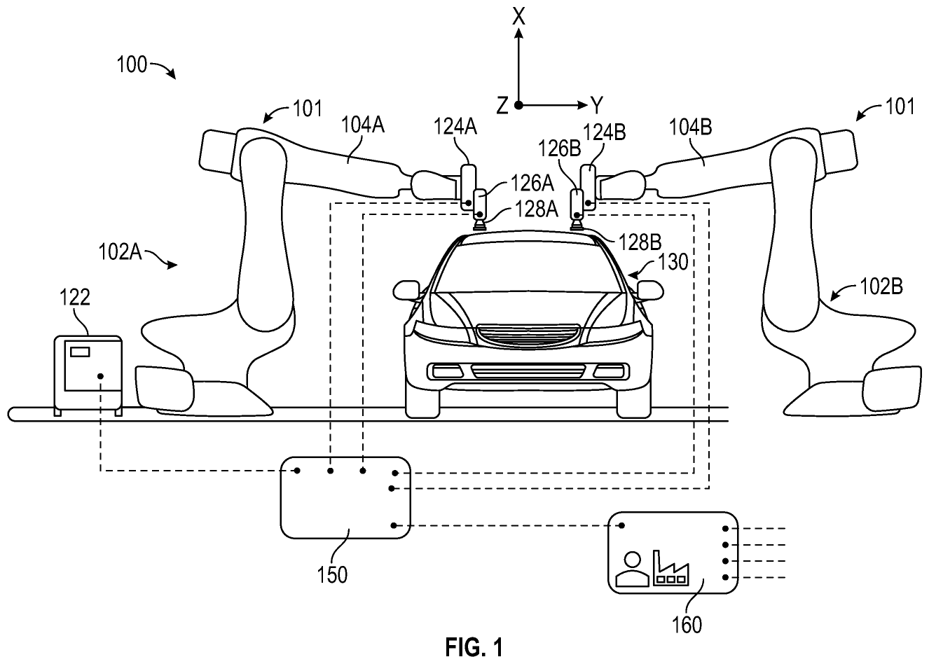

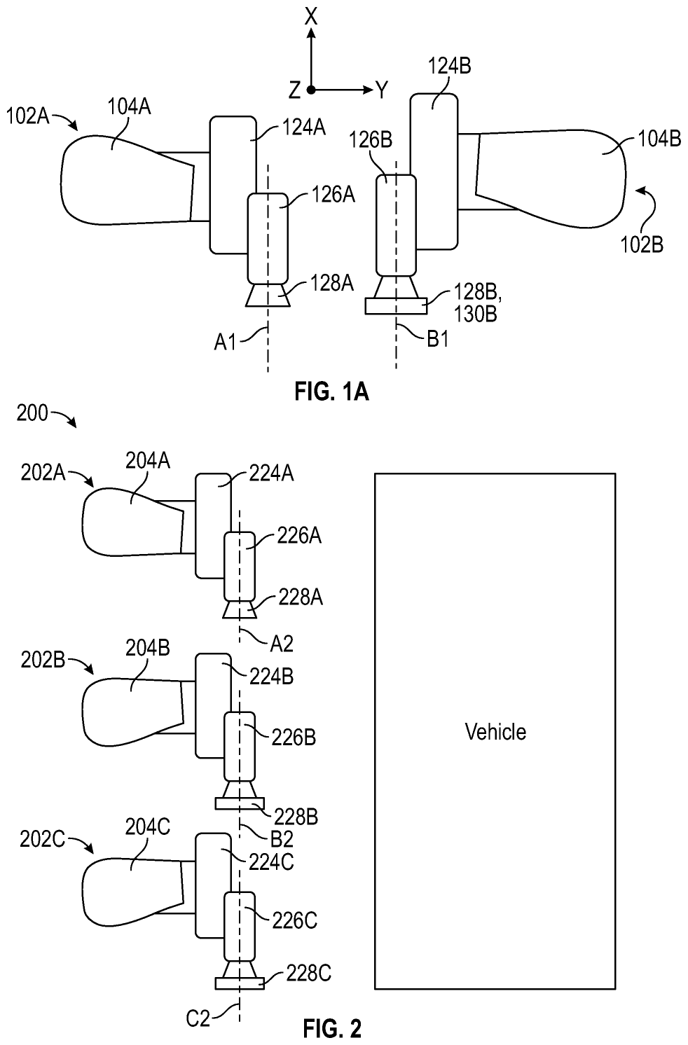

It should be understood that although an illustrative implementation of one or more embodiments are provided below, the disclosed systems and/or methods described with respect to FIGS. 1-7 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Whenever the terms “about an actuation axis” or “actuation about an axis” or similar are used can mean rotational actuation, orbital actuation, or random orbital actuation. The term “along an actuation axis” or “actuation along an axis” or similar means linear actuation. As used herein the term “fluid” means any one or combination of a pure fluid, a fluid in combination with particulate such as a slurry, debris from surface modification or any of the like. The term “surface modification” or the like includes repair of a surface, abrading, scuffing, sanding, polishing, buffing or the like. The term “substantially parallel” means up to but not exceeding 5 degrees, inclusive, from parallel in orientation (i.e. between exactly parallel and angled 5 degrees from exactly parallel, inclusive). The term “a limited rotational orientation change” or “limited manipulation about a rotational axis” or the like can mean a rotational orientation change of between 0.1 degrees and 45 degrees, inclusive.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

FIG. 1 is a schematic of a robotic paint repair system 100. The system 100 can include a visual inspection system (not shown) and a defect repair system 101. Each system may include subunits including a robotic repair unit 102A including a robotic arm 104A and a robotic repair unit 102B including a robotic arm 104B. The systems may be controlled by a motion controller, which may receive instructions from one or more application controllers 150. The application controller may receive input, or provide output, to a user interface 160.

Robotic repair unit 102A includes a force control unit 124A that can be aligned with an end effector 126A. Robotic repair unit 102B includes a force control unit 124B that can be aligned with an end effector 126B. As illustrated in FIG. 1, the force control unit 124A can be coupled to the end effector 126A, which is coupled to a tool 128A. The force control unit 124B can be coupled to the end effector 126B, which is coupled to a tool 128B. Tools 128A and/or 128B may be arranged, in one embodiment, as further described such as those described in U.S. Provisional patent applications with Ser. Nos. 62/940,950 and 62/940,960, both filed Nov. 2, 2019. However, other arrangements are also expressly contemplated. Visual inspection unit may detect defects on a vehicle surface 130, which may then be repaired by the defect repair system 101.

Robotic repair units 102A and/or 102B may have a base fixed to a rail system configured to travel along with a vehicle being repaired, or may be mounted on a wall or ceiling carrier. Depending on a defect location, robotic repair unit 102A and/or 102B may need to move closer, or further away from a vehicle, or may need to move higher or lower with respect to the vehicle. A moveable base may make repairing difficult-to-reach defects easier.

FIG. 1 shows a Cartesian coordinate system illustrated for reference with x-axis, y-axis and z-axis. It is recognized that according to some examples the robotic repair unit 102B may not be offset across the vehicle in the y-axis direction from the robotic repair unit 102A. Rather, the robotic repair unit 102B can be placed in another location such as on the same side of the vehicle as the robotic repair unit 102A and offset in the z-axis direction, for example. The position of the tools 128A and 128B can be varied by manipulation of the respective robotic repair unit 102A and/or 102B and/or as the result of other actuators.

FIG. 1A is a schematic view of portions of the robotic repair units 102A and 102B. As shown in FIG. 1A, the robotic arm 104A and/or 104B can be capable of movement in any of six dimensions, translations or rotations about an x-axis, y-axis and/or z-axis. Robotic repair unit 102A has the force control unit 124A and the end effector 126A with one or more tools 128A that can interact with a worksurface such as the vehicle surface 130 (FIG. 1). The tool 128A may include a backup pad, in one embodiment, or another suitable abrasive tool. During an abrasive operation, tool 128A may have an abrasive disc, or other suitable abrasive article, attached using adhesive, hook and loop, clip system, vacuum or other suitable attachment system. As mounted to the robotic repair unit 102A, the tool 128A has the ability to be positioned within the provided degrees of freedom by the robotic repair unit 102A (6 degrees of freedom in most cases) and any other degrees of freedom (e.g., a compliant force control 124A unit) with its reference frame.

FIG. 1A additionally shows the robotic repair unit 102B has the force control unit 124A and the end effector 126B with one or more tools 128A that can interact with a worksurface such as the vehicle surface 130 (FIG. 1). The tool 128B can be mounted such that the tool 128A and the tool 128B share substantially parallel actuation axes A1 and B1, respectively. Put another way, the tool 128A can have a first axis A1 about which the tool 128A is configured to rotate to perform surface modification of the workpiece. The tool 128B can have a second axis B1 about which the tool 128B is configured to rotate or along which the tool 128A is configured to be actuated into contact with the workpiece to perform wiping. The first axis A1 can be offset from the second axis B1 in any one or combination of the x-axis direction, the y-axis direction and/or the z-axis direction. However, the first axis A1 can be orientated substantially parallel (5 degrees from parallel or less to exactly parallel) with the second axis B1 and substantially parallel with the second axis B1.

The tool 128B can comprise a wiping medium 130B (also referred to as a wiping solution herein). The wiping medium 130B can be a cloth, sponge or other medium for example capable of being pressed linearly along the second axis B1 against the workpiece and/or rotated about the second axis B1 so as to be dragged along the workpiece for removal of fluid and other residue from the workpiece. While the present tool 128B is shown as a removal tool using cloth or other medium, in other embodiments fluid removal tool 128B can be another type of tool including a movement system, such as a vacuum or air knife. Similarly, while systems and methods are described herein with respect to a linear, unidirectional wiping process, it is expressly removed that more complex motion, such as that of rotary, orbital or random orbital devices.

During the paint or clearcoat repair process, fluid may be dispensed on the workpiece prior to, during, or subsequent to the utilization of 128A. This process fluid may combine with particulate matter from the process to create a slurry. The particulate matter composing this slurry is generally caused by the sanding process, which usually takes place prior to a polish buffing step. Processing by tool 128A, without prior removal of this slurry, may have adverse effects on the final paint surface. Such adverse effects include a hazy or unbuffed appearance or undesired scratches or other damage in the final painted product, which can be caused by micro scratches. The improvement seen when the slurry is removed was unexpected, as it is not a standard for robotic repair systems to remove the slurry prior to surface buffing. The hazy or imperfect appearance is not observable on every buffed surface, but is most noticeable after a buildup of slurry or particulate matter on the buff pad as a result of sanding. The adverse effects of buildup on the buff pad were demonstrated by an experiment conducted on a clearcoat workpiece.

FIG. 2 shows a schematic of a system 200 including several robotic repair units 202A, 202B and 202C. This robotic repair units 202A, 202B and 202C can be arranged along a vehicle. The robotic repair units 202A, 202B and 202C each include an arm 204A, 204B and 204C, a force control unit 224A, 224B and 224C, end effectors 226A, 226B and 226C and tools 228A, 228B and 228C. The system 200 can be constructed in the manner described previously but can include separate robotic repair units 202A, 202B and 202C for manipulation of each respective tool 228A, 228B and 228C. Tool 228A can be an abrasive tool such as an abrasive pad configured for sanding the workpiece (vehicle surface). Tool 228B can be the wiping medium as previously described. Tool 228C can be an abrasive tool such as an abrasive pad configured for polishing or buffing the workpiece.

FIG. 2 shows a first axis A2 of actuation of the tool 228A can be substantially parallel with a second axis B2 of actuation of the tool 228B. The first axis A2 can be offset from the second axis B2. Similarly, the second axis B2 of actuation of the tool 228A can be substantially parallel with a third axis C2 of actuation of the third tool 228C. The second axis B2 can be offset from the third axis C2.

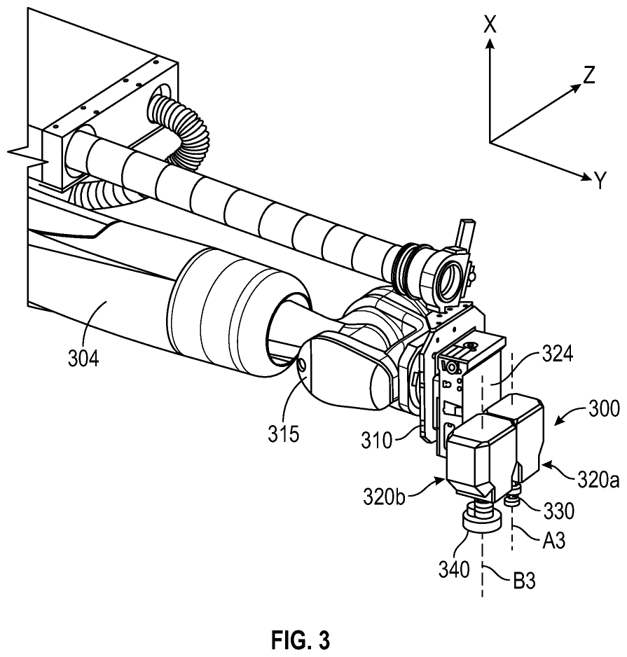

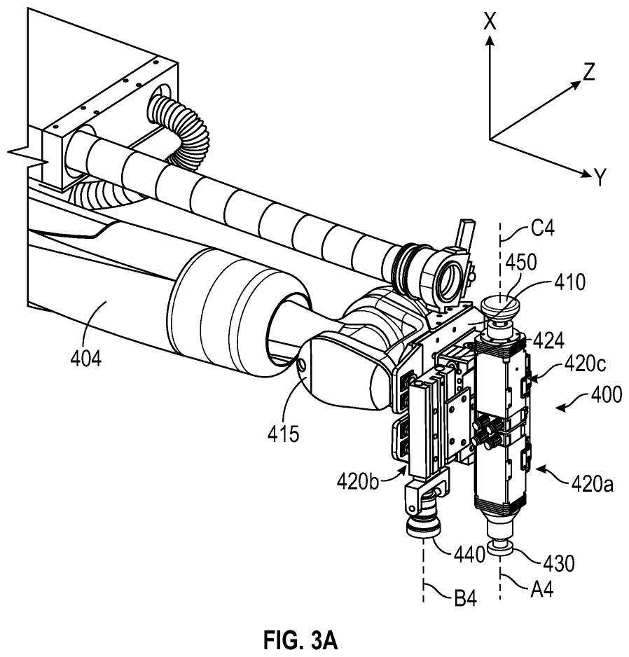

FIG. 3 illustrates a dual-mounted end effector system 300 on a robot arm 304. The robot arm 304 can move end effector system 300 through various movements including rotationally, using mounting adapter plate or wrist 310 and vertically, using a joint 315. A first end effector 320A can be configured to actuate a first surface modification tool 330 about a first actuation axis A3. A second end effector 320B can be configured to actuate a wiping medium 340 along and/or about a second actuation axis B3. In some embodiments, the robot arm 304 can move such that both the first tool 330 or the wiping medium 340 can be positioned to interact with a workpiece. Such movement however need not include rotation of the mounting adapter plate or wrist 310 about the x-axis, y-axis of z-axis. Alternatively, such rotational movement can be limited to a range of 45 degrees, 35 degrees, 25 degrees, 15 degrees, 10 degrees or less, for example. The system 300, as illustrated, can use a single force control unit 324, mounted to mounting adapter plate or wrist 310, to alternatively operate first tool 330 and the wiping medium 340. The first tool 330 can be offset from but positioned substantially parallel to the wiping medium 340 with respect to the actuation axis B3 thereof. Force control unit 324 can be used for both the first end effector 320A and the first tool 330 and the second end effector 320B and wiping medium 340.

The first tool 330 may be used for polishing, sanding, or other surface preparation purposes. The first tool 330 can be offset from the wiping medium 340 with respect to one or more of the x-axis, y-axis or z-axis of the Cartesian coordinate system for example. The wiping medium 340 can be used for liquid and residue removal as previously discussed. The end effectors 320A and/or 320B can be a pneumatically driven, servo driven, hydraulically driven or can be configured for actuation in some other known manner. The wiping medium 340 may incorporate a spring or pneumatic compliance source to allow for compliance upon applied pressure or force. Alternatively, the wiping medium 340 can be mounted such that it uses the same compliance tool that the first tool 330 is mounted to.

FIG. 3A illustrates a tri-mounted end effector system 400 on a robot arm 404. The robot arm 404 can move end effector system 400 through various movements including rotationally, using mounting adapter plate or wrist 410 and vertically, using a joint 415. A first end effector 420A can be configured to actuate a first surface modification tool 430 configured for sanding about a first actuation axis A4. A second end effector 420B can be configured to actuate a wiping medium 340 along and/or about a second actuation axis B4. In some embodiments, the robot arm 404 can move such that both the first tool 430 or the wiping medium 440 can be positioned to interact with a workpiece. Such movement however need not include rotation of the mounting adapter plate or wrist 410 about the x-axis, y-axis of z-axis. Alternatively, such rotational movement can be limited to a range of 45 degrees or less, for example. A third end effector 420C can be configured to actuate a second surface modification tool 450 configured for polishing about a third actuation axis C4. The system 400, as illustrated, can use a single force control unit 424, mounted to plate 410, to alternatively operate the first tool 430, the second tool 450 and the wiping medium 440. The first tool 430 can be offset from but positioned substantially parallel to the wiping medium 440 with respect to the actuation axis B4 thereof. Force control unit 424 can be used for both the first end effector 420A and the first tool 430, the second end effector 420B and wiping medium 440 and the third end effector 420C and the second tool 450. Alternatively, the second end effector 420B for the wiping medium 440 may incorporate a spring or pneumatic compliance source to allow for compliance upon applied pressure or force. As shown, the wiping medium 440 can be mounted such that it uses the same compliance tool that the first tool 430 is mounted to.

While the second tool 450 is mentioned as configured for buffing the workpiece, such that second tool 450 could alternatively be a second tool configured for sanding (similar to the first tool). Alternatively, both the first and second tools 430 and 450 can configured for buffing. Additionally, other possible combinations or orders of the two tools 430 and 450 are contemplated. For example, the second tool 450 can be configured as a wiping medium according to a further example. Additionally or alternatively, a second additionally wiping medium can be part of the end effector system 400. This second wiping medium could be arranged offset and substantially parallel with the axis C4 of the second tool 450, for example.

The first tool 430 can be offset from the wiping medium 440 with respect to one or more of the x-axis, y-axis or z-axis of the Cartesian coordinate system for example. The second tool 450 can be mounted to oppose the first tool 430 such that the wrist 410 must be rotated to bring the second tool 450 into surface modification position. However, it is contemplated the second tool 450 can be oriented or offset by less than 180 degrees such as between 90 degrees and 180 degrees, inclusive, according to other examples.

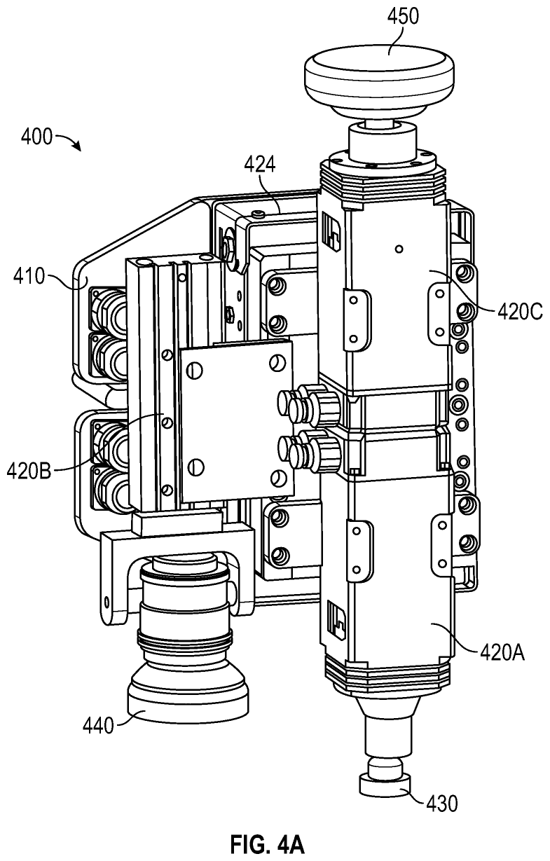

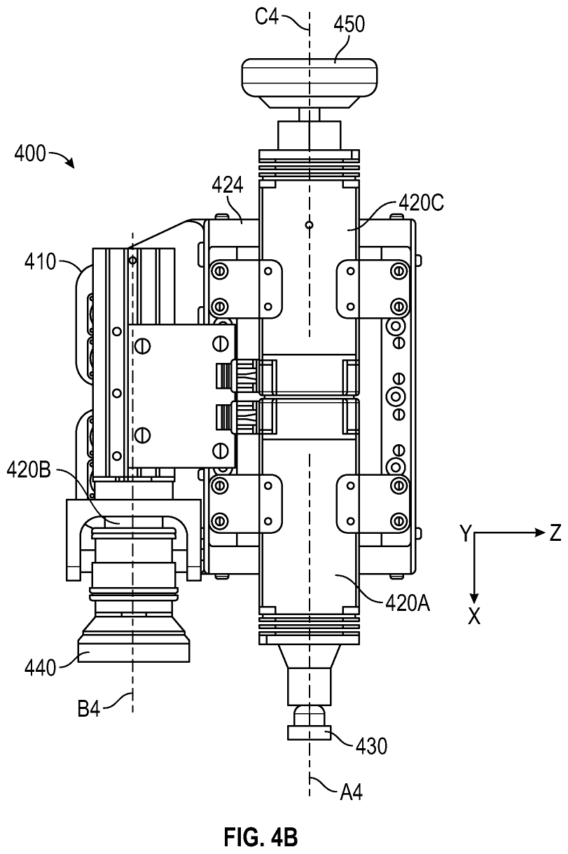

FIGS. 4A and 4B show the views of the tri-mounted end effector system 400 including the mounting adapter plate or wrist 410, the force control unit 424, the first end effector 420A, the second end effector 420B and the third end effector 320C, the first tool 430, the wiping medium 440 and the second tool 450. The axes A4, B4 and C4 are also illustrated. FIG. 4B additionally shows the first tool 430 can be offset from the wiping medium 440 with respect to one or more of the x-axis, y-axis or z-axis of the Cartesian coordinate system for example. However, at least the first actuation axis A4 of the first end effector 420A and first tool 430 can be substantially parallel with the second actuation axis B4 of the second end effector 420B of the wiping medium 440. FIGS. 4A and 4B show the second end effector 420B and the wiping medium 440 in retracted position relative to the first tool 430 to allow the first tool 430 clearance to perform grinding and to avoid or reduce the possibility of interference.

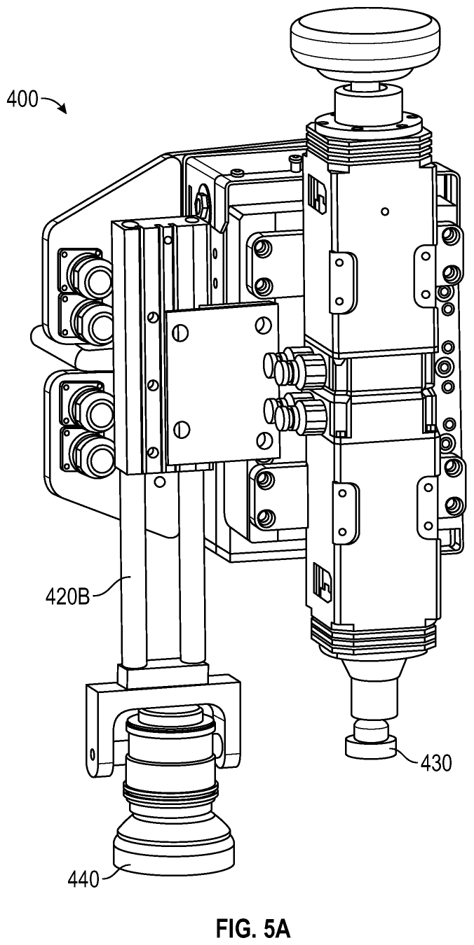

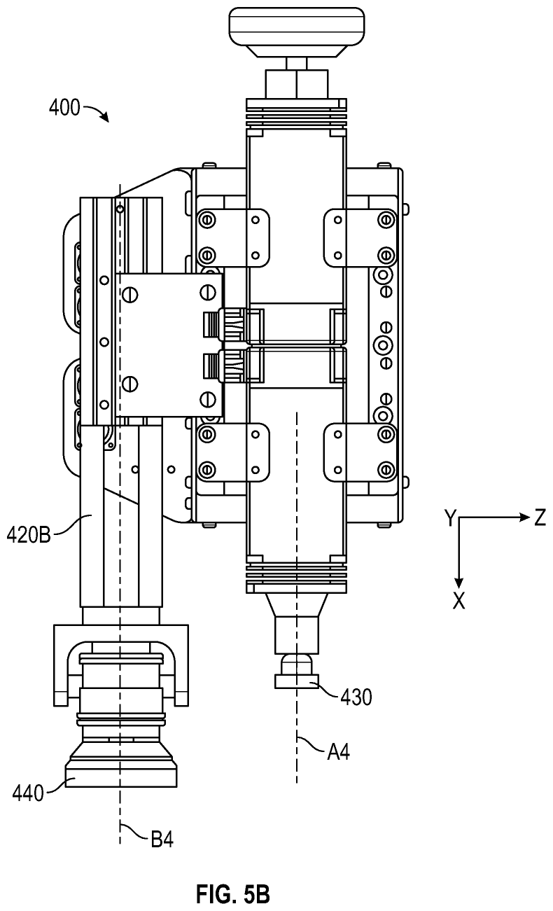

FIGS. 5A and 5B show the tri-mounted end effector system 400 with the second end effector 420B and the wiping medium 440 in an extended position relative to the first tool 330 to allow the wiping medium 440 clearance to perform removal of slurry and liquid from the workpiece and to reduce the possibility of interference.

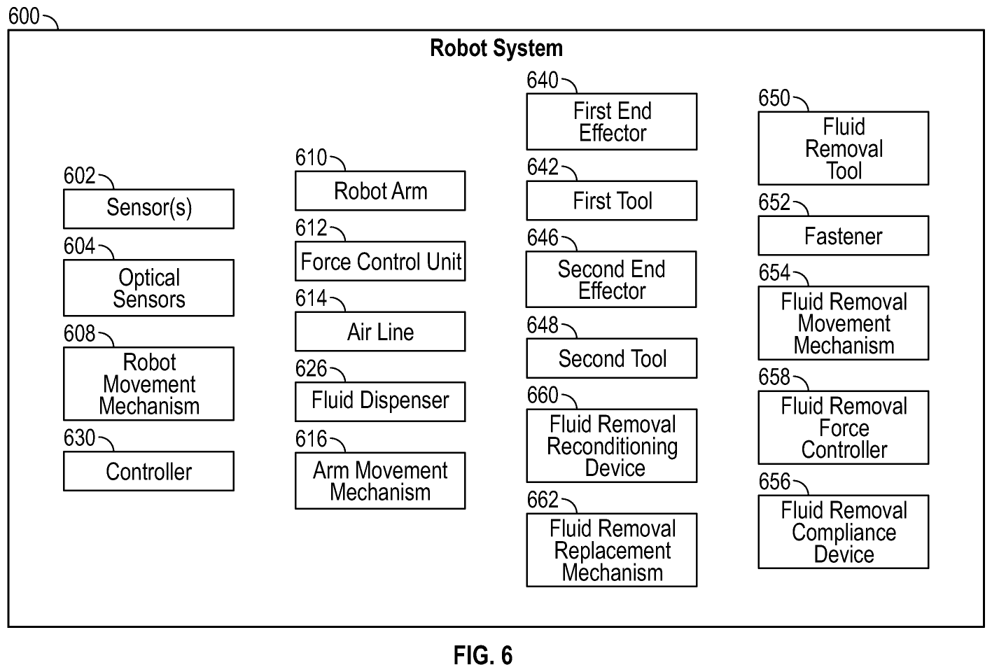

FIG. 6 illustrates a schematic of a robotic repair system 500. Robotic repair system 500 may be useful for sanding and polishing defects on a worksurface in accordance with embodiments herein. The work surface may be a vehicle, in some embodiments, such as an automobile, a car, a truck, a boat, an airplane, helicopter, etc.

Robotic repair system 500, in one embodiment, has optical sensors 504, which may be used to locate paint/clearcoat blemishes or areas to be repaired. Robotic repair system 500 includes a robot moving mechanism 508, which may be used to move an end-of-arm assembly into proximity of a defect repair area. As illustrated in FIG. 6, in one embodiment, robotic repair system 500 includes a controller 530 which controls movement and sensing of robot arm 510 and related components. However, it is expressly contemplated that, in some embodiments, robot arm 510 and/or components mounted thereon have their own controllers which receive and execute movement and sensing commands from controller 530.

In some embodiments, at the end of robot arm 510 is an end-of-arm assembly which can include a variety of tools, as illustrated in previous FIGURES, for example. However, it is expressly contemplated, as illustrated in FIG. 6, that, in other embodiments, some components may be located elsewhere on one or more motive robot arms 510.

A first abrasive tool 542 may be mounted on robot arm 510. The first abrasive tool, in some embodiments, is coupled to a first end effector 540. In some embodiments, a second abrasive tool 548 is mounted to robot arm 510. Second tool 548 may be coupled to a second end effector 546. A fluid removal mechanism 560 may be mounted to a robot arm 510. However, it is expressly contemplated that, in some embodiments, some of these components may on more than one robot arm 510. For example, a first robot arm 510 could support a first abrasive tool 542, e.g., a sanding robot with a sanding tool, and a second robot arm 510 could support a second abrasive tool, e.g., a polishing robot with a polishing tool.

In one embodiment, robot arm 510 is moved into place by arm movement mechanism 516. Abrasive tools 542, 548 and fluid removal mechanism 560 may also be moved into place by arm movement mechanism 516, in one embodiment, or may each have their own movement mechanism that moves them into position on workpiece surface.

A force control unit 512 may also be located on robot arm 510 to control interactions between the robot arm 510, end effector systems, and a workpiece surface.

In some embodiments, air line 514 and fluid dispenser 526 feed from robot arm 510 to the end effector system to provide necessary air and fluid supply for operating first tool 542 and second tool 548.

In an embodiment, fluid removal tool 550 is also coupled to force control unit 512. Fluid removal tool 550 may be, for example, a fabric-based wiping medium, an air knife, a vacuum system, or another suitable tool. However, it is also contemplated that, in some embodiments, fluid removal tool 550 is coupled to a separate force control unit than that used for tool 542 or tool 548. It is also contemplated that, in other embodiments, fluid removal tool 550 is a passive tool with no associated force control unit. In some embodiments, fluid removal tool 550 is mounted in a fixed position on robot arm 510. A fastener 552 may be used to fix fluid removal tool 550 in a position to allow for passive wiping, in some embodiments. Fastener 552 may be extendable, or coupled to force control unit 512 to facilitate semi-passive wiping, in some embodiments.

Robot arm 510 may also include a fluid removal compliance device 556 which may provide force compliance for the fluid removal compliance device 556. Fluid removal compliance device 556 may be a passive compliance device, such as a flexible or compressible material that urges a wiping medium toward a worksurface. In other embodiments, fluid removal compliance device 556 is a mechanical device, such as a mechanical spring or a pneumatic air cylinder.

In some embodiments, fluid removal tool 550 may be moved through space using a fluid remover movement mechanism 554. Movement mechanism 554 will control variables such as the pitch, tilt, and yaw of an active wiping motion of fluid removal tool 550.

In some embodiments fluid removal tool 550 may function in conjunction with fluid removal force control unit 558. Force control unit 558 may maintain proper force or pressure between fluid removal tool 550 and the workpiece. Fluid removal force control unit 558 may be mounted to robot arm 510, and supply signal or control through fastener 552 to fluid removal tool 550. In other embodiments, pressure or tension on the workpiece surface is regulated by fluid removal compliance device 556.

Fluid removal tool 550 may function in conjunction with a fluid removal mechanism 560, in some embodiments. Fluid removal mechanism 560 may be a pad, vacuum, brush, or scraping tool used to remove particulate matter, debris, liquid or slurry from the wiping medium of fluid removal tool 550. Fluid removal mechanism 560 may help to provide a suitably absorbent and effective wiping medium for cleaning the workpiece surface more than once.

In another embodiment, fluid removal tool 550 may include a replaceable component, for example a new absorbent pad when an old one is saturated with fluid or debris. A fluid removal replacement mechanism 562 may facilitate replacement of the wiping medium fluid removal tool 550. In some embodiments, replacement mechanism 562 is a release clip, button or hook and loop system used to quickly exchange saturated or exhausted wiping medium.

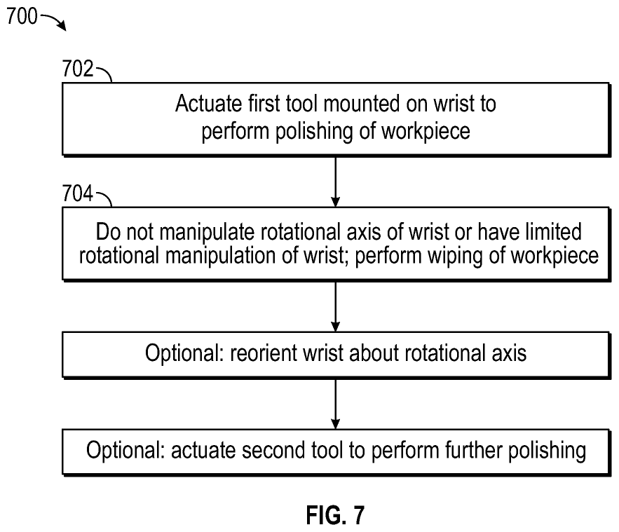

FIG. 7 shows a method 700 of performing automated paint repair on a workpiece. The method can include actuating a first tool mounted to a robotic arm via a wrist to perform surface modification of the workpiece 702. The method can include wiping 804 of the workpiece after the surface modification of the workpiece. Wiping can be done without manipulating a rotational axis of a wrist of the robotic arm or with manipulating the wrist about the rotational axis within a limited range (e.g., between 0.1 degrees and 45 degrees, inclusive). Optionally, surface modification of the workpiece with one of sanding or buffing the workpiece. Optionally, the method 700 can include reorientating the wrist about the rotational axis and actuating a second tool mounted to the robotic arm via the wrist to perform the buffing of the workpiece after the wiping of the workpiece. Alternatively, the method 700 can include actuating a second tool to perform the buffing of the workpiece after the wiping of the workpiece. The method 700 can optionally include wiping of the workpiece after the buffing of the workpiece. The method 700 can include the surface modification of the workpiece by the first tool is performed about a first axis and the wiping of the workpiece after surface modification the workpiece is performed along a second axis. The first axis is offset from and substantially parallel (no more than 5 degrees from exactly parallel in orientation) with the second axis. In another example, the first axis and the second axis are no more than 45 degrees from parallel in orientation. Thus, the first and second axis can be 45 degrees, 35 degrees, 25 degrees, 20 degrees, 15 degrees, 10 degrees or less. The method 700 can include extending or retracting a wiping solution that is configured to perform the wiping axially along the second axis relative to the first tool.

In one or more examples, the functions described can be implemented in hardware, software, firmware, or any combination thereof, located locally or remotely. If implemented in software, the functions can be stored on or transmitted over a computer-readable medium as one or more instructions or code and executed by a hardware-based processing unit. Computer-readable media can include computer-readable storage media, which corresponds to a tangible medium such as data storage media, or communication media including any medium that facilitates transfer of a computer program from one place to another, e.g., according to a communication protocol. In this manner, computer-readable media generally can correspond to (1) tangible computer-readable storage media which is non-transitory or (2) a communication medium such as a signal or carrier wave. Data storage media can be any available media that can be accessed by one or more computers or one or more processors to retrieve instructions, code and/or data structures for implementation of the techniques described in this disclosure. A computer program product can include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions can be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein can refer to any of the foregoing structures or any other structure suitable for implementation of the techniques described herein. In addition, in some aspects, the functionality described herein can be provided within dedicated hardware and/or software modules. Also, the techniques could be fully implemented in one or more circuits or logic elements.

The techniques of this disclosure can be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units can be combined in a hardware unit or provided by a collection of interoperative hardware units, including one or more processors as described above, in conjunction with suitable software and/or firmware.

The functions, techniques or algorithms described herein may be implemented in software in one example. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the examples described are merely examples. The software may be executed on a digital signal processor, ASIC, microprocessor, or other type of processor operating on a computer system, such as a personal computer, server or other computer system, turning such computer system into a specifically programmed machine

Various examples have been described. These and other examples are within the scope of the following claims.

1. A robotic paint repair system comprising:
a robotic arm;
a first tool system comprising a first end effector coupled to a first tool configured to contact a workpiece to perform surface modification of the workpiece, wherein the first end effector is configured to actuate the first tool about a first axis to perform the surface modification of the workpiece; and
a fluid removal tool comprising a wiping medium, wherein the fluid removal tool is coupled to the robot arm, wherein the fluid removal tool is configured to actuate the wiping medium about or along a second axis to remove fluid from the workpiece;
wherein the first axis is offset from the second axis and the first axis is within 45 degrees of parallel with the second axis.

2. The robotic paint repair system of claim 1, wherein the first axis and the second axis are substantially parallel being no more than 5 degrees from parallel in orientation.

3. The robotic paint repair system of claim 1, wherein the first tool system is coupled to the robotic arm offset from the fluid removal tool.

4. The robotic paint repair system of claim 1, further comprising a second tool system comprising a second end effector coupled to a second tool configured to contact the workpiece, wherein the second tool system is coupled to the robotic arm.

5. The robotic paint repair system of claim 4, wherein the first and second tools are positioned between 90 degrees and 180 degrees apart, inclusive, on the robotic arm.

6. The robotic paint repair system of claim 4, wherein the fluid removal tool, the first end effector, and the second end effector are mounted to a same force control device.

7. The robotic paint repair system of claim 1, wherein the wiping medium is extensible and retractable axially along the second axis relative to the first tool.

8. The robotic paint repair system of claim 1, wherein surface modification of the workpiece includes one of sanding, polishing or buffing the workpiece.

9. The robotic paint repair system of claim 1, wherein the first tool system is coupled to the robotic arm via a flange along with the fluid removal tool, and wherein the flange does not change a rotational orientation between the first tool performing the surface modification of the workpiece and the wiping medium removing fluid from the workpiece.

10. The robotic paint repair system of claim 1, wherein the first tool system is coupled to the robotic arm via a flange along with the fluid removal tool, and wherein the flange has a limited rotational orientation change between the first tool performing the surface modification of the workpiece and the wiping medium removing fluid from the workpiece.

11. The robotic paint repair system of claim 1, wherein the first tool system is coupled to a second robotic arm.

12. The robotic paint repair system of claim 1, wherein the fluid comprises a sanding slurry.

13. The robotic paint repair system of claim 1, wherein the fluid removal tool and the first end effector are mounted to a same force control device.

14. A robotic paint repair system comprising:
a robotic arm;
a first tool system comprising a first end effector coupled to a first tool configured to contact a workpiece to perform a first surface modification of the workpiece, wherein the first end effector is configured to actuate the first tool about a first axis to perform the first surface modification of the workpiece;
a second tool system comprising a second end effector coupled to a second tool configured to contact the workpiece; and
a fluid removal tool comprising a wiping medium, wherein the fluid removal tool is coupled to the robot arm, wherein the fluid removal tool is configured to actuate the wiping medium about or along a second axis to remove fluid from the workpiece;
wherein the first axis is offset from and substantially parallel with the second axis.

15. The robotic paint repair system of claim 14, wherein the first tool and the second tool are coupled to the robotic arm via a same force controller, and wherein the second tool is configured to perform one of a second surface modification of the workpiece or a second removal of fluid from the workpiece.

16. The robotic paint repair system of claim 14, wherein the wiping medium is extensible and retractable axially along the second axis relative to the first tool or the second tool.

17. The robotic paint repair system of claim 14, wherein the first tool system is coupled to the robotic arm via a flange along with the fluid removal tool, and wherein the flange does not change a rotational orientation between the first tool performing the first surface modification of the workpiece and the wiping medium removing fluid from the workpiece.

18. The robotic paint repair system of claim 14, wherein at least one of the first tool system and the second tool system is coupled to a second robotic arm.

19. (canceled)

20. A method of performing automated paint repair on a workpiece, the method comprising:
actuating a first tool mounted to a robotic arm to perform surface modification of the workpiece;
moving a tool configured to perform wiping of the workpiece without manipulating a rotational axis of a wrist of the robotic arm; and
wiping of the workpiece with the tool.

21. (canceled)

22. The method of claim 20, further comprising:
reorientating the wrist about the rotational axis; and
actuating a second tool mounted to the robotic arm via the wrist to perform buffing of the workpiece after the wiping of the workpiece; and
wiping of the workpiece after the buffing of the workpiece.

23.-28. (canceled)
